(19) United States
(12) Patent Application Publication
(10) Pub. No.: US 2014/0263205 A1
(43) Pub. Date: Sep. 18, 2014

(54) TORCH HEIGHT MECHANSIM

(71) Applicant: Jamil Snead, San Diego, CA (US)

(72) Inventor: Jamil Snead, San Diego, CA (US)

(73) Assignee: Lincoln Global, Inc., City of Industry, CA (US)

(21) Appl. No.: 13/838,961

(22) Filed: Mar. 15, 2013

(51) Int. Cl. B23K 37/02

(52) U.S. Cl. CPC B23K 37/02
USPC 219/121.56

(57) ABSTRACT

A torch height adjustment mechanism includes a welding torch head connected to a torch plate; a first four-bar linkage between the torch plate and a linkage interface; a second four-bar linkage between the linkage interface and a mounting plate for connecting the torch-height adjustment mechanism to an automatic welding unit; a shaft providing rotational movement to the second four-bar linkage; and means for communicating rotational movement of a first link of the second four-bar linkage to a first link of the first four-bar linkage to translate the torch plate vertically without rotation along a path between a raised position and a lowered position.

### TECHNICAL FIELD

Certain embodiments relate to welding systems, devices, and processes. More particularly, certain embodiments relate to a system and/or method for positioning and adjusting the position of a welding torch relative to a work space in any of brazing, cladding, building up, filling, hard facing overlaying, joining and other welding applications.

### BACKGROUND

This patent document relates to welding systems, devices, and processes.

Welding in large industrial applications, e.g., metal inert gas (MIG) and tungsten inert gas (TIG) pipe or plate welding, can involve welding together very thick work pieces. Welding torches in these large industrial application are often movable in three or more dimensions, allowing the torch head to move horizontally along X and Y axes as well as vertically along a Z axis.

It is preferred that the torch head is able to move independently along the X, Y, and Z axes in order to minimize error in welding. Horizontal movement along the X and Y axes is typically controlled by a track or other movable apparatus. In adjusting the height of the motorized welding torch, it is desired to move the torch so that it remains perpendicular to the work surface throughout the entire stroke and keep the torch in a set position on the X-Y plane. Finally, it is desired to provide a large stroke of height adjustment while keeping a low profile of the weld head. A variety of methods and apparatus have been proposed.

According to a first proposed solution, the torch head is mounted to a linear track or rail system (e.g. V rollers on tracks, carriages on tracks, or linear bearings on shafts) that adjusts the head along the track, maintaining the head in a vertical position and fixed relative to the X-Y plane. This arrangement requires that the track length is greater than the stroke, so in order to achieve a sufficiently large stroke, low clearance is sacrificed.

According to a second proposed solution, the torch head is located at the end of a long arm. The arm may be sufficiently long so that rotating the arm produces a small horizontal movement in the X-Y plane with a large movement in the vertical Z direction. This arrangement requires some small horizontal movement in the X or Y direction and does not allow the torch head to remain perpendicular, requiring some angular rotation of the torch head about the X or Y axis.

According to a third proposed solution, a four-bar parallel linkage mechanism is proposed. The four-bar linkage includes a torch attached to a first link and two parallel links extending away from the first link. A fourth link joins the parallel links. By applying a rotational force to one of the parallel links, the torch link is moved up and down and maintained in a perpendicular direction to the X-Y plane. However, as the torch moves up and down, there is some lateral movement. If the workspace is not perfectly flat, then the torch will not stay perpendicular to the workspace. Even if the workspace is flat, the additional lateral movement is not desired.

Therefore, it is desired to produce a mechanism for adjusting the vertical position of a weld torch in an automated welding assembly that allows the orientation of the torch to be maintained without moving the torch in a horizontal direction. It is also desired to have a mechanism for adjusting the position of the weld torch that allows for a large stroke with low clearance.

### SUMMARY

The invention includes a torch height adjustment mechanism that has a welding torch head connected to a torch plate; a first four-bar linkage between the torch plate and a linkage interface; a second four-bar linkage between the linkage interface and a mounting plate for connecting the torch-height adjustment mechanism to an automatic welding unit; a shaft providing rotational movement to the second four-bar linkage; and means for communicating rotational movement of a first link of the second four-bar linkage to a first link of the first four-bar linkage to translate the torch plate vertically without rotation along a path between a raised position and a lowered position.

According to various improvements, first four-bar linkage of the torch height adjustment mechanism may have two parallel and equal length links. The second four-bar linkage may also have two parallel and equal length links. Links of the first and second four-bar linkages may be connected at a shared pivot point that may transfer rotational movement between links.

The means for translating rotational movement may include one or more gears, such as partial gears having intersecting teeth. The gears may be a first and second gear each connected to respective four-bar linkages. One or more intermediate gears between the first and second gears may be provided.

Also disclosed is a method for adjusting the height of a welding torch relative to a work surface. The method includes the steps of providing a welding torch adjustment mechanism with first and second four-bar linkages; securing a welding torch to a torch plate of the adjustment mechanism; securing a mounting plate of the adjustment mechanism to a welding machine, rotating a shaft of the mechanism; transferring rotational movement between the first and second four-bar linkages; and vertically translating the welding torch while maintaining the orientation and horizontal position of the torch.

The method may also include a gears for transferring rotational movement from one of the four-bar linkages to another. The method may also include the step of rotating the shaft until the welding torch reaches a preferred height.

Also disclosed is a welding torch system with a welding mechanism, a welding torch head in electrical communication with the welding mechanism, a torch height adjustment mechanism with two four-bar linkages, and means for communicating rotational movement from one of the four-bar linkages to the other for translating the welding torch vertically along a path without rotation between first and second positions.

### BRIEF DESCRIPTION OF THE DRAWINGS

FIG. 1 is a front perspective view of a torch height mechanism according to the invention;

FIG. 2 is a rear perspective view of the torch height mechanism;

FIG. 3 is a partially exploded front perspective view of the torch height mechanism;

FIG. 4 is a partially exploded rear perspective view of the torch height mechanism;

FIG. 5 is a front plan view of the torch height mechanism;

FIG. 6 is an exploded perspective view of the torch height mechanism;

FIG. 7A is a front plan view of the four-bar linkage of the torch height mechanism in a first position; and

FIG. 7B is a front plan view of the four-bar linkage of the torch height mechanism in a second position.

FIG. 8 is a front plan view of an alternative embodiment of the torch height mechanism similar to FIG. 7B.

### DETAILED DESCRIPTION OF THE DRAWINGS

Reference will now be made to the attached drawings, wherein reference numerals refer to their like therein.

A four-bar linkage is a series of four linkages (e.g. A, B, C, D) connected end-to-end with one another at connection points (e.g. A-B, B-C, C-D, and D-A) to form a quadrilateral. Each of the four linkages is allowed to rotate freely about the connection point, but translational motion is transferred between adjacent linkages at the connection point. By rotating one of the links about a first point (e.g. link A about connection point A-D), the opposite end of the link is translated, thereby causing the connected link to translate and rotate as constrained by the remaining links.

FIG. 1 is a perspective view of the torch height adjustment mechanism 100 according to one embodiment of the invention. The torch height adjustment mechanism 100 has a torch plate 102 that supports a welding torch 104 having a torch body 106 and a torch head 108. The torch head 108 may include an electrode when performing arc welding, as shown. It is contemplated that torch head 108 may include other welding assemblies including but not limited to laser welding/cutting assemblies, water jet nozzles, or other implements used in soldering and brazing applications. Also provided is a mounting plate 110 that connects the torch height adjustment mechanism 100 to the welding machine (not shown). The torch plate 102 is connected to the mounting plate 110 by a first linkage 112 and second linkage 114. The first 112 and second linkages 114 are connected at a linkage interface 116, the details of which are shown in further detail in FIGS. 3-4 and described with reference thereto. A shaft 118 connected to the welding machine is alternatively rotatable clockwise and counter-clockwise to adjust the height of the torch plate 102 and welding torch 104.

With reference to FIGS. 2 and 3, a first linkage 112 includes a pair of parallel arms 120, 122 and the second linkage 114 includes parallel arms 124, 126. The mounting plate 110 may include receivers 128, such as screw holes, threaded holes, pin openings, or other structures that secure the mounting plate 110 to the welding machine.

In FIG. 3, covers of the first 112 and second 114 linkages have been removed and the linkage interface 116 is shown in an exploded view. Linkage interface includes a front cover 130 and rear cover 132 that form a housing. Connection between and interaction of the first linkage 112 with the second linkage 114 is shown in further detail.

According to one embodiment, the first arm of the first linkage 120 pivots about a first pivot point 134 and includes a first gear 140 (FIG. 4) that may be a partial gear. The first gear 140 pivots about the first pivot point 134. The first arm of the second linkage 124 pivots about a second pivot point 136 and includes a second gear 142 that may be a partial gear. The first 140 and second 142 gears have teeth that interact with one another to transfer rotational motion between first gear 140 and second gear 142. In the embodiment shown, the gear ratio between gears 140,142 is 1:1. It is contemplated that other ratios may be used, such as, when the lengths of the links are not the same.

Further according to FIG. 3, the second arm of the first linkage 122 and the second arm of the second linkage 126 may both freely pivot about a shared pivot point 138. Rotational motion of these arms is not communicated between these links, but translational motion of the arms will be communicated. The shared pivot point 138 may be fixed as shown by securing the shared pivot point 138 to front cover 130. It will be appreciated that fixation of the shared pivot point 138 may occur on either front cover 130, rear cover 132 or both. Alternatively, another structure within the housing or linkage interface 116 may be used to fix shared pivot point 138. In the example shown, a horizontal plane P (FIG. 5) extends through the center of housing 132. First gear 140 and second gear 142 may engage each other along plane P. Also, shared pivot point 138 may be fixed along plane P.

FIG. 4 is a partial exploded rear perspective view of the primary embodiment of the torch height adjustment mechanism 100. Similar to FIG. 3, the front cover 130 and rear cover 132 of the linkage interface 116 have been removed. The linkage interface 116 is shown in further detail, illustrating the partial first gear 140 and second gear 142 and their interaction. The gears 140, 142 rotate about the first 134 and second 136 pivot points and have a constant radius, and therefore will remain in toothed engagement as the related links 120, 124 rotate about the pivot points 134, 136.

With reference to FIGS. 5 and 6, first gear 140 and second gear 142 may be located within a housing 132. Housing 132 may also support pivot point 138, which as discussed in more detail below is fixed. In the embodiment shown, housing 132 includes a plate that defines a gear receiver 133 in which the gears 140,142 are received. Gear receiver 133 may be an opening through the plate with gears 140,142 received completely therein. Alternatively, it is contemplated that receiver 133 may be a recess, notch or other partial opening that receives at least a portion of gears 140,142. In addition, it is contemplated that separate receivers may be provided for each gear 140,142 with an opening between the two receivers through which the gears mesh.

In the example shown, an opening 137 is provided to conform to a circular pivot 138. Pivot 138 is rotatably supported in a bearing 135, such as a ball bearing. The pivot shaft, which as shown may be threaded to facilitate attachment. This pivot is provided as an example and is not limiting. As shown, similar pivot structures may be mounted in bearing 135 may be used at any of the pivot points described herein including, as shown, 134,136,138, 150, 151, and 152. It will be appreciated that dissimilar pivot structures and bearings may be used at each pivot.

FIGS. 7A-B show the torch height adjustment mechanism 100 including the first 112 and second 114 four-bar linkages. Representative links A, B, C, D for the first four-bar linkage 112 and E, F, G, H for the second four-bar linkage 114 are shown as dashed lines. These links extend between pivot points and may not precisely conform to actual physical components. The members forming these links are shown as generally straight elongate plates or bars, but may have other shapes or configurations depending on the application.

Referring to the first four-bar linkage 114, link A extends between the shared pivot point 138 and a first position on the torch plate; link B extends between first and second positions on the torch plate 102; link C extends from the second position on the torch plate to the first pivot point 134; and link D extends between the first pivot point 134 and the shared pivot point 138.

Referring to the second four-bar linkage 116, link E extends between the second pivot point 136 and shaft 118; link F extends between the shaft 118 and a point on the mounting plate 110; link G extends between the mounting plate 110 and the shared pivot point 138; and link H extends between the shared pivot point 138 and second pivot point 136.

The various links described above for the four-bar mechanism will also have related features. Links A and C; B and D; E and G; and F and H form pairs that are parallel and equal length. Links A and G share a common pivot point 138. The lengths of the various links will be selected so that as link E is rotated by and about the shaft 118, the distance H1 between the mounting plate 110 and torch plate 102 is increased. During this movement, the vertical alignment of the torch plate 102 will be maintained.

According to one embodiment, the absolute angle of link D relative to a horizontal axis equal to the absolute angle of link H relative to a horizontal axis. For example, as shown, link H extends at an angle above horizontal at the same angle that link D extends below horizontal. According to the embodiment shown in FIG. 7B, the pivot points 134,136 of links D and H may be vertically aligned with each other. This embodiment is not limiting as the same angular relationship may be maintained with pivot points 134, 136 in a non vertically aligned position.

For example in an alternative embodiment depicted in FIG. 8, first gear 140 may be provided on link A and second gear 142 may be provided on link G causing the pivot points of links D and E to be spaced from each other. The angles (Θ₁, Θ₂) of links D and H relative to a horizontal plane extending through the junction of gears 140,142 are maintained equal to each other.

It is further contemplated that gears 140,142 may be located to join a link of the first four bar linkage to a link of the second four bar linkage other than the links shown. For example, one gear may be located on link A and engage a gear located on link E. Likewise configurations where the shared pivot 138 is eliminated are also contemplated by the invention. For example when links A and E are connected through gears, links C and G would not have a shared pivot point and may be attached at separate pivot points on linkage interface 116.

FIG. 7B shows the first 112 and second 114 four-bar linkages in a second arrangement where the distance between the torch plate 102 and mounting plate 110 has increased to distance H2. In this arrangement the alignment of the torch plate 102 is maintained relative to the position of the mounting plate 110. Because the mounting plate 110 is attached to the welding machine, the position of the welding torch 104 to the work piece (not shown) is maintained.

Also disclosed is a novel method for adjusting the height of a welding torch relative to a work surface. A welding torch adjustment mechanism 100 as described above is first provided. The mechanism 100 includes first 112 and second 114 four-bar mechanisms connecting a torch plate 102 and a mounting plate 110. A shaft is connected to the second four-bar linkage 114 and provides rotational movement to a first link of the linkage 124. A welding torch 104 is secured to the torch plate 102 and the mounting plate 110 is secured to an automatic welding machine. The shaft 118 may be rotated to rotate the first link 124 of the second four-bar linkage 114. This rotation causes the second four-bar linkage 114 to transfer rotational (e.g. through first 134 and second gears 136) and translational (e.g. through shared pivot 138) movement from the second four-bar linkage 114 to the first four-bar linkage 112. This transfer causes the torch plate 102 to vertically translate relative to the mounting plate 110 while maintaining the orientation and horizontal position of the torch plate 102.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Only a few implementations and examples are described and other implementations, enhancements and variations can be made based on what is described and illustrated in this patent document.

In summary, while the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A torch height adjustment mechanism comprising:
a welding torch head connected to a torch plate;
a first four-bar linkage between the torch plate and a linkage interface;
a second four-bar linkage between the linkage interface and a mounting plate for connecting the torch-height adjustment mechanism to an automatic welding unit;
a shaft providing rotational movement to the second four-bar linkage; and
means for communicating rotational movement of a first link of the second four-bar linkage to a first link of the first four-bar linkage to translate the torch plate vertically without rotation along a path between a raised position and a lowered position.

2. The torch height adjustment mechanism according to claim 1 wherein the first four-bar linkage includes two parallel and equal length links.

3. The torch height adjustment mechanism according to claim 2 wherein the second four-bar linkage includes two parallel and equal length links.

4. The torch height adjustment mechanism according to claim 3 wherein a link opposite the first link of the first four-bar linkage is connected to a link parallel to the second link of the second four-bar linkage at a shared pivot point.

5. The torch height adjustment mechanism according to claim 4 wherein the shared pivot point is fixed.

6. The torch height adjustment mechanism according to claim 5, wherein the shared pivot point and the means for communicating rotational movement are aligned along a common plane.

7. The torch height adjustment mechanism according to claim 1 wherein means for communicating rotational movement of the first link of the second four-bar linkage to a first link of the first four-bar linkage comprises a first gear connected to the first link of the first four-bar linkage and a second gear connected to the first link of the second four-bar linkage.

8. The torch height adjustment mechanism according to claim 7 wherein the first and second gears comprise partial gears.

9. The torch height adjustment mechanism according to claim 7 further comprising a housing including a plate, wherein the plate defines an opening that receives the first gear and the second gear therein wherein the first gear and second gear mesh along a plane; wherein the plate further defines a pivot receiver adapted to receive a shared pivot, the shared pivot being common to the first four bar linkage and the second four bar linkage, wherein the shared pivot is fixed by the plate and within the plane.

10. The torch height adjustment mechanism according to claim 7, wherein the first gear has a pivot point and the second gear has a pivot point, wherein the pivot point of the first gear and the pivot point of the second gear are vertically aligned with each other.

11. The torch height adjustment mechanism according to claim 1, wherein the first four bar linkage includes a first pivot point, the second four bar linkage includes a second pivot point, and wherein the first four bar linkage and second four bar linkage are attached to each other to a shared pivot point, wherein the first pivot point, second pivot point, and shared pivot point are fixed relative to each other on a housing.

12. The torch height adjustment mechanism according to claim 1, wherein the first link of the first four bar linkage has a first pivot point and the first link of the second four bar linkage has a second pivot point different from the first pivot point, and wherein a second link of the first four bar linkage extends from the first pivot point at a first angle and a second link from the second four bar linkage extends from the second pivot point at a second angle, wherein the first angle and the second angle have an absolute angle equal to each other.

13. The torch height adjustment mechanism according to claim 1, wherein the lengths of the links forming the first four bar linkage are equal to the lengths of the corresponding links in the second four bar linkage.

14. A welding torch system comprising:
a welding torch head;
a torch height adjustment mechanism for mechanically adjusting the height of the welding torch, the torch height adjustment mechanism comprising:
a torch plate supporting the torch head;
a first four-bar linkage including a first pivot point;
a second four-bar linkage including a second pivot;
wherein the first four bar linkage and second four bar linkage are connected at a shared pivot point;
a linkage interface including a housing, wherein the linkage interface includes a first hear attached to the first four bar linkage and rotatable about the first pivot point, and a second gear attached to the second four bar linkage and rotatable about the second pivot point, wherein the first gear and the second gear are engageable with each other in a plane and wherein the shared pivot point is lies within the plane;
a shaft providing rotational movement to the second four-bar linkage; wherein rotation of the shaft is communicated to the first four bar linkage at the linkage interface to translate the torch plate along a path between a raised position and a lowered position.
